(19) United States
(12) Patent Application Publication
(10) Pub. No.: US 2015/0327283 A1
(43) Pub. Date: Nov. 12, 2015

(54) Antenna Selection for Coordinated Multipoint Uplink Reception

(71) Applicant: NOKIA SOLUTIONS AND NETWORKS OY, Espoo (FI)

(72) Inventors: Christian MAHR, Ulm (DE); Gottfried SCHNABL, Ulm (DE)

(21) Appl. No.: 14/648,303

(22) PCT Filed: Nov. 30, 2012
(86) PCT No.: PCT/EP2012/074087

§ 371 Date: May 29, 2015

(51) Int. Cl. H04W 72/08; H04W 72/04; H04B 7/08; H04L 5/00

(52) U.S. Cl. CPC H04W 72/085; H04L 5/0035; H04W 72/048; H04B 7/0834

(57) ABSTRACT

There are provided measures for antenna selection for coordinated multipoint uplink reception. Such measures exemplarily include determining, for each antenna of a plurality of antennas, a quality of reception on a physical uplink control channel, and selecting, from said plurality of antennas, based on said determining, a set of a predetermined number of antennas to be used for reception on a physical uplink shared channel.

### FIELD

The present invention relates to antenna selection for coordinated multipoint uplink reception. More specifically, the present invention exemplarily relates to measures (including methods, apparatuses and computer program products) for realizing antenna selection for coordinated multipoint uplink reception.

### BACKGROUND

The present specification generally relates to coordinated multipoint (CoMP) implementation in wireless network deployments. Coordinated Multipoint comprises different techniques that allow dynamic coordination of transmission and reception over a plurality of base stations. The aim is to improve overall quality experienced by the users as well as improving the utilization of the network at all. In particular, the present specification relates to control mechanisms for coordinated multipoint in relation to uplink connections.

For CoMP transmission in the uplink direction, user equipment (UE) transmissions can be received not only in the cell the UE is camped on (e.g. center cell), but also in neighbor cells, as exemplarily shown in FIG. 1, illustrating a UE in proximity of several neighbor cells. Presently, usage of CoMP in the uplink requires that some neighbor cell antenna information is included into the receiving process. It is noted that usually all neighbor cells are known to the evolved NodeB (eNB) of the cell the UE is camped on e.g. by the automatic neighbor cell relation (ANR) feature for handover purposes.

Typically, processing capabilities of an eNB for additional antenna data from neighbor cells are substantially lower than the number of neighbor cell candidates. For example, six to 20 potential neighbor cells may be present while a physical uplink shared channel (PUSCH) receiver of the eNB might have capacity to process data only from one or two additional neighbor cells along with the primary cell the UE is camped on.

Selection of the antennas best suited for receiving data on PUSCH is non-trivial. It is noted that such a selection is UE-specific, since different UEs have different locations and thus different propagation conditions.

There are further scenarios in heterogeneous networks (HetNet) where a correct selection of additional neighbor cells is even more important. For example, since the major signal contribution may come from a neighbor pico cell even though the UE is camped on the covering macro cell, as exemplarily shown in FIG. 2, illustrating a UE in proximity of a pico cell (pico eNB) in such a HetNet scenario.

Thus, the problem arises that a simple antenna selection scheme is to be found to enable a useful uplink CoMP scheme for PUSCH reception within the physical uplink protocol layer.

Hence, there is a need to provide for antenna selection for coordinated multipoint uplink reception.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising determining, for each antenna of a plurality of antennas, a quality of reception on a physical uplink control channel, and selecting, from said plurality of antennas, based on said determining, a set of a predetermined number of antennas to be used for reception on a physical uplink shared channel.

According to an exemplary aspect of the present invention, there is provided an apparatus comprising a determining module configured to determine, for each antenna of a plurality of antennas, a quality of reception on a physical uplink control channel, and a selecting module configured to select, from said plurality of antennas, based on determination of said determining module, a set of a predetermined number of antennas to be used for reception on a physical uplink shared channel.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient selection of the antennas best suited for receiving data on PUSCH to thereby solve at least part of the problems and drawbacks identified above.

By way of exemplary embodiments of the present invention, there is provided antenna selection for coordinated multipoint uplink reception. More specifically, by way of exemplary embodiments of the present invention, there are provided measures and mechanisms for realizing antenna selection for coordinated multipoint uplink reception.

Thus, improvement is achieved by methods, apparatuses and computer program products enabling/realizing antenna selection for coordinated multipoint uplink reception.

### BRIEF DESCRIPTION OF THE DRAWINGS

In the following, the present invention will be described in greater detail by way of non-limiting examples with reference to the accompanying drawings, in which

FIG. 1 is a schematic diagram illustrating an example of a disposal of neighbor cells around a central cell,

FIG. 2 is a schematic diagram illustrating an example of a disposal of pico cells covered by a macro cell,

FIG. 3 is a block diagram illustrating an apparatus according to exemplary embodiments of the present invention,

FIG. 4 shows a schematic diagram of exemplary signaling between means according to exemplary embodiments of the present invention,

FIG. 5 is a schematic diagram of a procedure according to exemplary embodiments of the present invention, and

FIG. 6 is a block diagram alternatively illustrating an apparatus according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, CoMP processing in uplink transmission in the field of mobile radio, in particular relating to Long Term Evolution (LTE) and Long Term Evolution Advanced (LTE-A) is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) antenna selection for coordinated multipoint uplink reception.

According to exemplary embodiments of the present invention, the “useful” neighbor cell antennas for the PUSCH reception of UEs transmissions towards the eNB are pre-selected by the use of a physical uplink control channel (PUCCH) signal.

Namely, according to exemplary embodiments of the present invention, the PUCCH receive quality is used as selection criteria for the antennas to be used for PUSCH reception for a specific UE.

In an eNB, at least three different receivers per cell are required according to the physical channels to be received by eNB. Namely, receivers for physical random access channel (PRACH), PUCCH and PUSCH are required.

As soon as a radio link has been established between eNB and UE, the PUCCH is continuously scheduled while the PUSCH is scheduled only when uplink data is available.

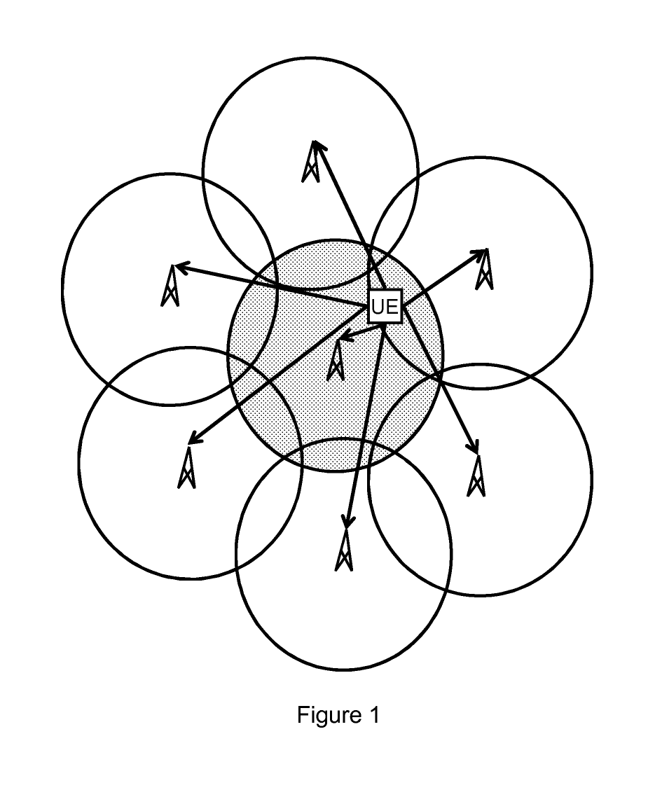

FIG. 1 is a schematic diagram illustrating an example of a disposal of neighbor cells around a central cell.

As is derivable from FIG. 1, uplink signals transmitted from the UE towards an eNB of the (central) cell the UE is camped on (i.e. the hatched cell) are received by the target eNB as well as by antennas spanning the neighbor cells. In CoMP scenarios, those uplink signals received by the antennas spanning the neighbor cells may be utilized.

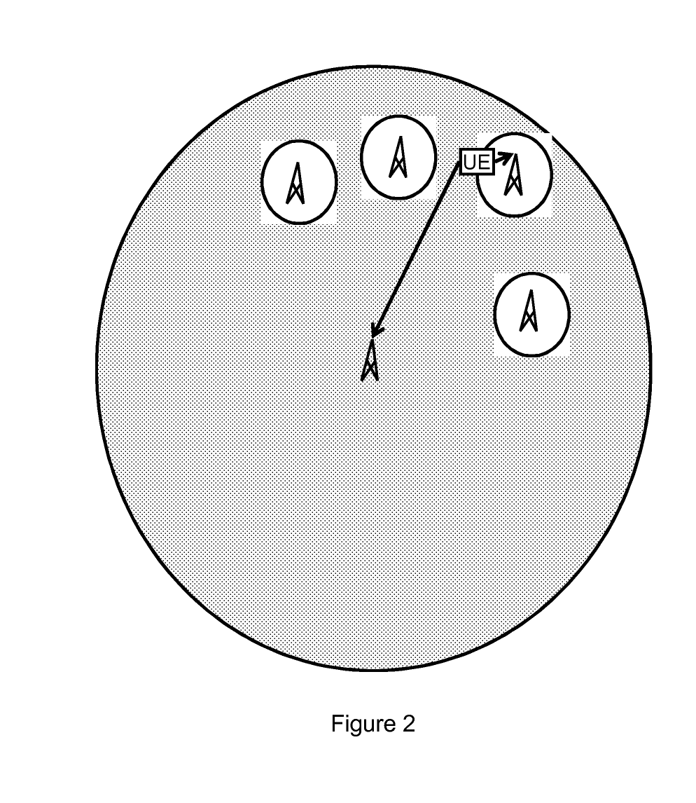

FIG. 2 is a schematic diagram illustrating an example of a disposal of pico cells covered by a macro cell.

As is derivable from FIG. 2, uplink signals transmitted from the UE towards an eNB of the (macro) cell the UE is camped on (i.e. the hatched cell) are received by the target eNB as well as by antennas spanning pico cells located within the macro cell. In CoMP scenarios, those uplink signals received by the antennas spanning the pico cells may be utilized.

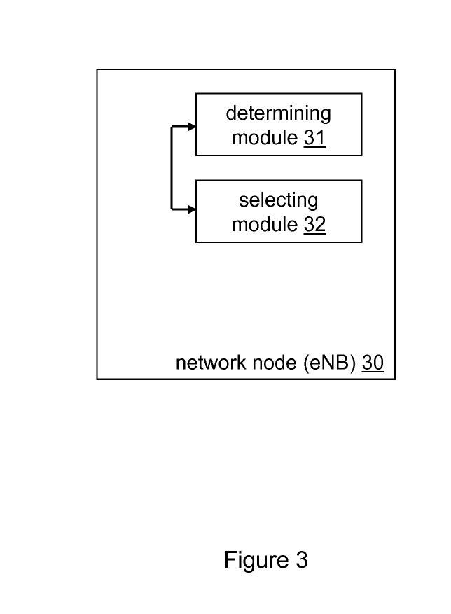

FIG. 3 is a block diagram illustrating an apparatus according to exemplary embodiments of the present invention.

As shown in FIG. 3, according to exemplary embodiments of the present invention, the apparatus is a network node 30 comprising a determining module 31 and a selecting module 32. The determining module 31 determines, for each antenna of a plurality of antennas, a quality of reception on a physical uplink control channel. The selecting module 32 selects, from said plurality of antennas, based on determination of said determining module 31, a set of a predetermined number of antennas to be used for reception on a physical uplink shared channel.

That is, according to exemplary embodiments of the present invention, the PUCCH receive quality is used as selection criteria for the antennas to be used for PUSCH reception for a specific UE.

Whenever a UE transmission is scheduled on PUSCH, the set of antennas selected by the PUCCH receiver is then used instantaneously for the PUSCH reception.

Thus, the PUSCH receiver operates only on a fixed maximum number of antennas according to its capabilities.

It is noted that it is to the discretion to the PUSCH receiver to discard antenna data from an antenna of said selected set, e.g. if an antenna signal is still too noisy.

According to exemplary embodiments of the present invention, the apparatus further comprises an inputting module and an evaluating module. The inputting module inputs, regularly and sequentially, from each antenna of said plurality of antennas, a signal corresponding to said reception of said physical uplink control channel. The evaluating module evaluates said respective signals.

In other words, the PUCCH receiver has one or more additional receiver inputs. The additional receiver input(s) scan(s) the other neighbor cell antenna candidates (from an overall handover candidate list obtained by ANR) in a regular fashion and evaluates the reception quality thereof.

According to further exemplary embodiments of the present invention, the apparatus further comprises a sorting module and an inserting module. The sorting module sorts said plurality of antennas by said respective quality of reception. The inserting module inserts said predetermined number of antennas having highest quality of reception into said set.

For each UE a specific selection of neighbor cell antennas (set) is kept, where the size of the set equals the number of antennas the PUSCH receiver can handle.

According to further exemplary embodiments of the present invention, the apparatus further comprises an updating module. The updating module updates a previous set with a recently selected predetermined number of antennas.

That is, whenever an antenna is found among the not yet selected neighbor cell antennas having a better reception quality, the set of antennas for a specific UE is updated, by e.g. replacing another antenna.

According to still further exemplary embodiments of the present invention, the apparatus further comprises an estimating module and a setting module. The estimating module estimates mobility of a transmission startpoint of a transmission on said physical uplink control channel. The setting module sets a regularity of input of said inputting module based on said estimated mobility. In addition, the setting sets an amount of time for which each of said respective signals is used by said evaluating module based on said estimated mobility.

In other words, observation time and filtering of the PUCCH antenna measurements are chosen appropriately according to an assumed mobility of the UE. That is, the periodicity with which the scan of the neighbor cell antennas is performed (observation window) is based on the mobility of the UE. If the UE is moving slowly, a scan cycle is not necessarily to be performed as often as if the UE is moving fast. Reason therefor is that the antenna constellations from the UEs view changes slower when the UE is moving slowly than when the UE is moving fast. Accordingly, the regularity is adapted to the mobility of the UE. Preferably, according to exemplary embodiments of the present invention, if the UE moves fast, more scan cycles are performed per time, while if the UE moves slowly, less scan cycles are performed per time.

Further, an evaluation may be performed by calculating an average value of the signal quality over a certain period of time (filtering). It is clear for the skilled person that an average value is only an example for a determination of a characteristic value of a certain period of time, and different ways of generating (filtering) such characteristic values are conceivable. When for evaluating the signals a portion of a respective signal corresponding to a certain period of time is used, the evaluation result is the better the longer the period of time is. However, in case the UE moves, the certain period of time inevitably considers different positions of the UE and thus different antenna constellations.

Accordingly, the certain period of time is adapted to the mobility of the UE. Preferably, according to exemplary embodiments of the present invention, if the UE moves fast, the certain period is set shorter, while if the UE moves slowly, the certain period is set longer.

According to still further embodiments of the present invention, the apparatus further comprises a receiving module and a deciding module. The receiving module receives, using each antenna of said set, a transmission on said physical uplink shared channel. The deciding module decides, from said set, based on said received transmission, a subset of at least two antennas to be used for subsequent reception on said physical uplink shared channel.

That is, as a variant of the proposed PUCCH based antenna selection method for CoMP reception of PUSCH is implemented as explained in the following. The neighbor cell antenna selection in the PUCCH receiver is a pre-selection of the known possible antenna candidates. The set of antennas preselected by the PUCCH receiver serve as an input to the PUSCH receiver. From this preselected set the PUSCH receiver performs a final selection of antennas to be used in the PUSCH reception processing. Such variation provides a benefit in certain scenarios, because besides the PUCCH signal also the PUSCH signal is used in the antenna selection process according to exemplary embodiments of the present invention.

According to still further exemplary embodiments, said quality of reception is one of at least a signal strength, a signal to noise and interference ratio (SNIR), and a block error rate (BLER). It is to be noted that the above signal characteristics are merely of exemplary nature and not limiting. To the contrary, further signal characteristics representing a receiving quality, i.e. an assessment of the usability of the receiving, are conceivable and not excluded. In addition, a combination of the above exemplarily stated or further characteristics may be implemented as said quality of reception.

According to further exemplary embodiments of the present invention, the selecting of the set may be based on a first characteristic or a first combination of characteristics, while the deciding of the subset may be based on a second characteristic or a second combination of characteristics different from the first.

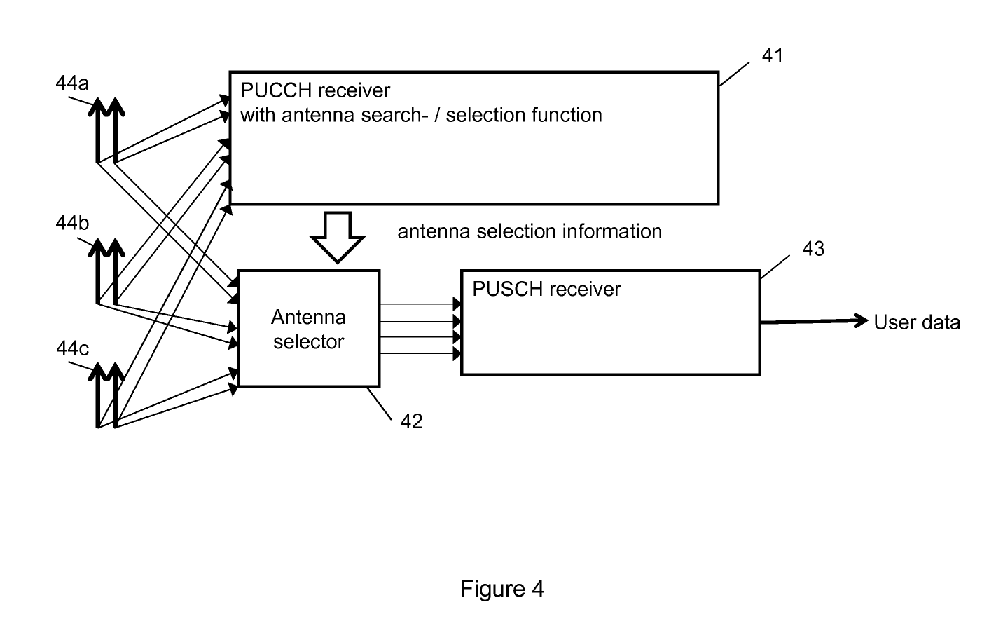

FIG. 4 shows a schematic diagram of exemplary signaling between means according to exemplary embodiments of the present invention.

On FIG. 4, two involved receivers (according to the present invention) of the required three receivers of an eNB are illustrated, namely a PUCCH receiver 41 and a PUSCH receiver 43. As is derivable from FIG. 4, the PUCCH receiver 41 inputs/receives PUCCH transmissions as received by the known candidate antennas (44a, 44b, 44c), and selects appropriate antennas based on the reception quality. That is, the PUCCH receiver 41 determines/selects useful antennas for a specific UE. The selected set is forwarded to an antenna selector 42 disposed upstream of the PUSCH receiver 43. According to the selected set, the PUSCH receiver 43 inputs/receives PUSCH transmissions from the selected set of antennas and processes the respective transmissions.

It is noted that the shown receiver structure/functionalities do not necessarily need to be concentrated in one eNB. Alternatively, according to further exemplary embodiments of the present invention, the different receiver functionalities are distributed across different eNBs. As an example, the PUCCH antenna candidate scanning and processing may be performed in a neighbor eNB.

According to exemplary embodiments, the set of useful antennas for PUSCH reception can be advantageously calculated prior to the receiving process of the PUSCH transmission, because PUCCH is active even if no data is scheduled on PUSCH. The continuous nature of PUCCH also allows for aggregating and filtering of such measurements while the PUSCH transmission may happen only occasionally, namely when scheduled.

Further, according to exemplary embodiments of the present invention, the PUCCH receiver can follow the mobility of the UE within the cell, i.e. detect changes in the set of useful antennas even if there are pauses in uplink data transmission (on PUSCH). However, it is noted that crossing cell boundaries would lead to a layer 3 (L3)-controlled handover.

As a further advantage, since no UE interaction is necessary according to the proposed antenna selection for coordinated multipoint uplink reception, it can be applied in uplink CoMP schemes for 3^{rd} Generation Partnership Project (3GPP) Rel-8 UEs.

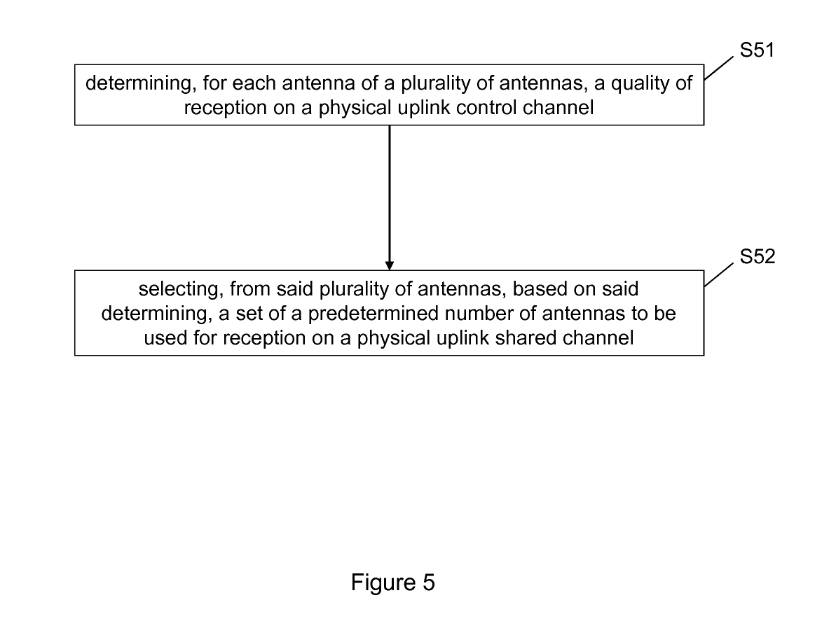

FIG. 5 is a schematic diagram of a procedure according to exemplary embodiments of the present invention.

As shown in FIG. 5, a procedure according to exemplary embodiments of the present invention comprises an operation of determining, for each antenna of a plurality of antennas, a quality of reception on a physical uplink control channel, and an operation of selecting, from said plurality of antennas, based on said determining, a set of a predetermined number of antennas to be used for reception on a physical uplink shared channel.

According to a variation of the procedure shown in FIG. 5, exemplary details of the determining operation are given, which are inherently independent from each other as such.

Such exemplary determining operation according to exemplary embodiments of the present invention may comprise an operation of inputting, regularly and sequentially, from each antenna of said plurality of antennas, a signal corresponding to said reception of said physical uplink control channel, and an operation of evaluating said respective signals.

According to a variation of the procedure shown in FIG. 5, exemplary details of the selecting operation are given, which are inherently independent from each other as such.

Such exemplary selecting operation according to exemplary embodiments of the present invention may comprise an operation of sorting said plurality of antennas by said respective quality of reception, and an operation of inserting said predetermined number of antennas having highest quality of reception into said set.

According to a variation of the procedure shown in FIG. 5, exemplary details of the selecting operation are given, which are inherently independent from each other as such.

Such exemplary selecting operation according to exemplary embodiments of the present invention may comprise an operation of updating a previous set with a recently selected predetermined number of antennas.

According to a variation of the procedure shown in FIG. 5, exemplary additional operations are given, which are inherently independent from each other as such. According to such variation, an exemplary method according to exemplary embodiments of the present invention may comprise an operation of estimating mobility of a transmission startpoint of a transmission on said physical uplink control channel, an operation of setting a regularity of said inputting based on said estimated mobility, and an operation of setting an amount of time for which each of said respective signals is used for said evaluating based on said estimated mobility.

According to a variation of the procedure shown in FIG. 5, exemplary additional operations are given, which are inherently independent from each other as such. According to such variation, an exemplary method according to exemplary embodiments of the present invention may comprise an operation of receiving, using each antenna of said set, a transmission on said physical uplink shared channel, and an operation of deciding, from said set, based on said received transmission, a subset of at least two antennas to be used for subsequent reception on said physical uplink shared channel.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification.

The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

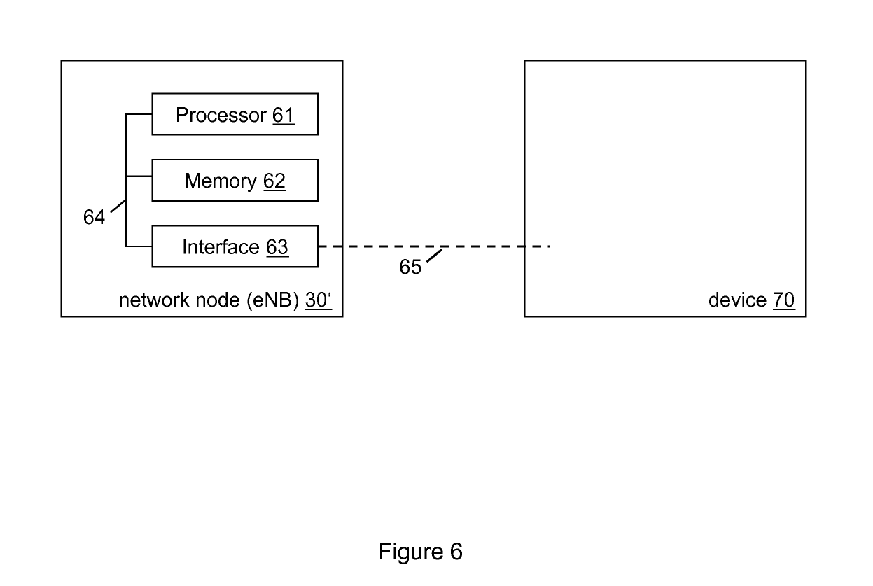

In FIG. 6, an alternative illustration of an apparatus according to exemplary embodiments of the present invention is depicted. As indicated in FIG. 6, according to exemplary embodiments of the present invention, the apparatus (network node) 30′ (corresponding to the network node 30) comprises a processor 61, a memory 62 and an interface 63, which are connected by a bus 64 or the like. The apparatus 30′ may be connected via link 65 with other devices 70.

The processor 61 and/or the interface 63 may also include a modem or the like to facilitate communication over a (hardwire or wireless) link, respectively. The interface 63 may include a suitable transceiver coupled to one or more antennas or communication means for (hardwire or wireless) communications with the linked or connected device(s), respectively. The interface 63 is generally configured to communicate with at least one other apparatus, i.e. the interface thereof.

The memory 62 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the network node 30 comprises at least one processor 61, at least one memory 62 including computer program code, and at least one interface 63 configured for communication with at least another apparatus. The processor (i.e. the at least one processor 61, with the at least one memory 62 and the computer program code) is configured to perform determining, for each antenna of a plurality of antennas, a quality of reception on a physical uplink control channel (thus the apparatus comprising corresponding means for determining), and to perform selecting, from said plurality of antennas, based on said determining, a set of a predetermined number of antennas to be used for reception on a physical uplink shared channel (thus the apparatus comprising corresponding means for selecting).

For further details regarding the operability/functionality of the apparatus, reference is made to the above description in connection with any one of FIGS. 3 to 6, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for antenna selection for coordinated multipoint uplink reception. Such measures exemplarily comprise determining, for each antenna of a plurality of antennas, a quality of reception on a physical uplink control channel, and selecting, from said plurality of antennas, based on said determining, a set of a predetermined number of antennas to be used for reception on a physical uplink shared channel.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

List of acronyms and abbreviations
3GPP 3^{rd} Generation Partnership Project
ANR automatic neighbor cell relation
CoMP coordinated multipoint
eNB evolved NodeB
HetNet heterogeneous networks
L3 layer 3
LTE Long Term Evolution
LTE-A Long Term Evolution Advanced
PRACH physical random access channel
PUCCH physical uplink control channel
PUSCH physical uplink shared channel
UE user equipment

1. A method comprising
determining, for each antenna of a plurality of antennas, a quality of reception on a physical uplink control channel, and
selecting, from said plurality of antennas, based on said determining, a set of a predetermined number of antennas to be used for reception on a physical uplink shared channel.

2. The method according to claim 1, wherein
in relation to said determining, said method further comprises
inputting, regularly and sequentially, from each antenna of said plurality of antennas, a signal corresponding to said reception of said physical uplink control channel, and
evaluating said respective signals.

3. The method according to claim 1, wherein
in relation to said selecting, said method further comprises
sorting said plurality of antennas by said respective quality of reception, and
inserting said predetermined number of antennas having highest quality of reception into said set.

4. The method according to claim 1, wherein
in relation to said selecting, said method further comprises
updating a previous set with a recently selected predetermined n umber of antennas.

5. The method according to claim 2, further comprising
estimating mobility of a transmission startpoint of a transmission on said physical uplink control channel,
setting a regularity of said inputting based on said estimated mobility, and
setting an amount of time for which each of said respective signals is used for said evaluating based on said estimated mobility.

6. The method according to claim 1, further comprising
receiving, using each antenna of said set, a transmission on said physical uplink shared channel, and
deciding, from said set, based on said received transmission, a subset of at least two antennas to be used for subsequent reception on said physical uplink shared channel.

7. The method according to claim 1, wherein
said quality of reception is one of at least a signal strength, a signal to noise and interference ratio, and a block error rate.

8. The method according to claim 1, wherein
the method is operable at or by a base station or access node of a cellular system, and/or
the method is operable in at least one of a LTE and a LTE-A cellular system.

9. An apparatus comprising
a determining module configured to determine, for each antenna of a plurality of antennas, a quality of reception on a physical uplink control channel, and
a selecting module configured to select, from said plurality of antennas, based on determination of said determining module, a set of a predetermined number of antennas to be used for reception on a physical uplink shared channel.

10. The apparatus according to claim 9, further comprising
an inputting module configured to input, regularly and sequentially, from each antenna of said plurality of antennas, a signal corresponding to said reception of said physical uplink control channel, and
an evaluating module configured to evaluate said respective signals.

11. The apparatus according to claim 9, further comprising
a sorting module configured to sort said plurality of antennas by said respective quality of reception, and
an inserting module configured to insert said predetermined number of antennas having highest quality of reception into said set.

12. The apparatus according to claim 9, further comprising
an updating module configured to update a previous set with a recently selected predetermined number of antennas.

13. The apparatus according to claim 10, further comprising
an estimating module configured to estimate mobility of a transmission startpoint of a transmission on said physical uplink control channel,
a setting module configured to set a regularity of input of said inputting module based on said estimated mobility, wherein
said setting module is further configured to set an amount of time for which each of said respective signals is used by said evaluating module based on said estimated mobility.

14. The apparatus according to claim 9, further comprising
a receiving module configured to receive, using each antenna of said set, a transmission on said physical uplink shared channel, and
a deciding module configured to decide, from said set, based on said received transmission, a subset of at least two antennas to be used for subsequent reception on said physical uplink shared channel.

15. The apparatus according to claim 9, wherein
said quality of reception is one of at least a signal strength, a signal to noise and interference ratio, and a block error rate.

16. The apparatus according to claim 9, wherein
the apparatus is operable as or at a base station or access node of a cellular system, and/or
the apparatus is operable in at least one of a LTE and a LTE-A cellular system.

17. A computer program product comprising computer-executable computer program code which, when the program is run on a computer, is configured to cause the computer to carry out the method according to claim 1.

18. The computer program product according to claim 17, wherein the computer program product comprises a computer-readable medium on which the computer-executable computer program code is stored, and/or wherein the program is directly loadable into an internal memory of the processor.
